(19) United States
(12) Patent Application Publication
(10) Pub. No.: US 2021/0319386 A1
(43) Pub. Date: Oct. 14, 2021

(54) DETERMINATION OF SAME-GROUP CONNECTIVITY

(71) Applicant: Microsoft Technology Licensing, LLC, Redmond, WA (US)

(72) Inventors: Jim Chang, Cupertino, CA (US); Raymond Keith Baker, JR., Hesperia, CA (US); Albert Lingfeng Cui, San Francisco, CA (US); Harshita Kasera, Mountain View, CA (US); Yunqing Zheng, Sunnyvale, CA (US); Dipen Thakkar, San Jose, CA (US); Chanh-Phap Nguyen, San Mateo, CA (US); Yu Xie, Sunnyvale, CA (US); Qunzeng Liu, Fremont, CA (US); Chloe Rosen, San Francisco, CA (US); Sriram Phani Kumar Palacharla, Fremont, CA (US); Emily Chachi Yeh, Sunnyvale, CA (US)

(21) Appl. No.: 16/844,721

(22) Filed: Apr. 9, 2020

(51) Int. Cl. G06Q 10/06; G06Q 50/00; G06N 20/00; G06K 9/62; H04L 29/08

(52) U.S. Cl. CPC G06Q 10/063112; G06Q 10/06393; H04L 67/306; G06N 20/00; G06K 9/6256; G06Q 50/01

(57) ABSTRACT

Methods, systems, and computer programs are presented for capturing teammate-connection information and leveraging this information to improve services of a social networking service. The teammates feature allows users to identify a subset of their connections as teammate connections, which are connections that work directly with the user as a manager, a peer (person reporting to the same manager as the user), or a direct report. The teammate-connection information is used for improving services and notifications, such as new-connection suggestions, construction of the user feed, group conversations and messaging, notification prioritization, etc. Unlike existing connection patterns, the teammate-connections information is structured data. The structured data provides a better understanding of the relationships among the users and allows optimization of the user experience. In one aspect, a method is presented to generate recommendations of possible teammates for users of the social networking service.

### TECHNICAL FIELD

The subject matter disclosed herein generally relates to methods, systems, and machine-readable storage media for managing connectivity within a social networking service and, more particularly, methods, systems, and machine-readable storage media for improving online services using information about member groups.

### BACKGROUND

Social networking services provide the ability to establish professional connections with other users. However, some linkages between users are stronger than others, which means that users are more interested in communicating and following users with strong professional connections.

The social networking services provide different types of services for their users (e.g., user feeds, chatting, communication suggestions) and the social networking services have to estimate the importance of communications to a particular user for selecting and prioritizing content. However, sometimes there is not enough information to distinguish between a strong professional connection and a weak professional connection.

What is needed is a mechanism to differentiate between the different types of professional links of users to enhance the services provided by the social networking services.

### BRIEF DESCRIPTION OF THE DRAWINGS

Various of the appended drawings merely illustrate example embodiments of the present disclosure and cannot be considered as limiting its scope.

FIG. 1 is a screenshot of a user feed, according to some example embodiments.

FIG. 2 is a user interface for managing connections, according to some example embodiments.

FIG. 3 is user interface for managing teammate relationships, according to some example embodiments.

FIG. 4 is a user interface for adding teammate connections, according to some example embodiments.

FIG. 5 is a user interface for managing teammate communications, according to some example embodiments.

FIG. 6A is a section of an organizational chart based on teammate connections, according to some example embodiments.

FIG. 6B illustrates the teammate and manager relationships for a group, according to some example embodiments.

FIG. 6C illustrates the determination of teammate connection scores indicative of a probability of possible teammate connections, according to some example embodiments.

FIG. 7 is a block diagram illustrating a networked system, according to some example embodiments, including a social networking server, illustrating an example embodiment of a high-level client-server-based network architecture.

FIG. 8 illustrates the uses of teammate connection information for improving connection suggestions, according to some example embodiments.

FIG. 9 illustrates the use of social networking service data to generate teammate recommendations, according to some example embodiments

FIG. 10 illustrates the training and use of a machine-learning program, according to some example embodiments.

FIG. 11 is a flowchart of a method for determining teammate connections, according to some example embodiments.

FIG. 12 is a block diagram illustrating an example of a machine upon or by which one or more example process embodiments described herein may be implemented or controlled.

### DETAILED DESCRIPTION

Example methods, systems, and computer programs are directed to determining teammate connections. Examples merely typify possible variations. Unless explicitly stated otherwise, components and functions are optional and may be combined or subdivided, and operations may vary in sequence or be combined or subdivided. In the following description, for purposes of explanation, numerous specific details are set forth to provide a thorough understanding of example embodiments. It will be evident to one skilled in the art, however, that the present subject matter may be practiced without these specific details.

The teammates feature allows users to identify a subset of their connections as teammate connections, which are connections that work directly with the user as a manager, a peer (person reporting to the same manager as the user), or a direct report. The teammate-connection information is used for improving services and notifications, such as new-connection suggestions, construction of the user feed, group conversations and messaging, the notification prioritization, etc.

Unlike existing connection patterns, the teammate-connections information is structured data. In one aspect, the teammates connections, also referred to herein as simply teammates, are categorized as manager, teammates reporting to the same manager, direct reports, or other teammates. The structured data provides a better understanding of the relationships among the users and allows optimization of the user experience.

One general aspect includes a method that includes an operation for training a machine-learning (ML) algorithm with training data to generate an ML model. The training data includes confirmed-teammate data on an online service, user profile data from the online service, and company information. Further, the method includes an operation for calculating, by the ML model, one or more teammate scores for a first user of the online service. Each teammate score is associated with a probability that a respective user has a teammate connection with the first user. Further, the method includes operations for determining if the one or more teammate scores are above a predetermined threshold, and for generating one or more teammate suggestions for the teammate scores that are above the predetermined threshold. The one or more teammate suggestions are presented to the first user on a user interface.

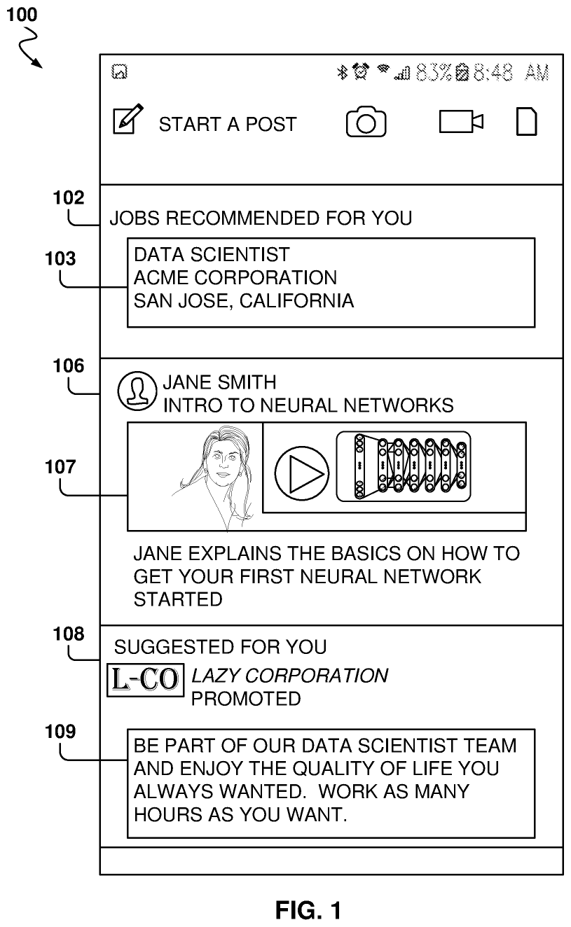

FIG. 1 is a screenshot of a user feed 100 that includes items in different categories, according to some example embodiments. In the example embodiment of FIG. 1, the user feed 100 includes different categories, such as job recommendations 102, user posts 106, and sponsored items 108; other embodiments may include additional categories such as news, messages, articles, etc.

The user posts 106 include item 107 posted by users of the social network service (e.g., items posted by connections of the user), and may be videos, comments made on the social network, pointers to interesting articles or webpages, etc. In the illustrated example, the item 107 includes a video submitted by a user.

In one example embodiment, a social network service user interface provides the job recommendations 102 (e.g., job posts 103 and 109) that match the job interests of the user and that are presented without a specific job search request from the user, referred to herein as “jobs you may be interested in” (JYMBII). In other example embodiments, the user feed 100 includes suggestions or recommendations (not shown in FIG. 1) for adding new connections, a feature referred to herein as People You May Know (PYMK).

Although the categories are shown as separated within the user feed 100, the items from the different categories may be intermixed, and not just presented as a block. Thus, the user feed 100 may include a large number of items from each of the categories, and the social network decides the order in which these items are presented to the user based on the desired utilities. Additionally, the user may receive in-network communications from other users. The communications may originate by other users who are socially connected with the user or by unconnected users.

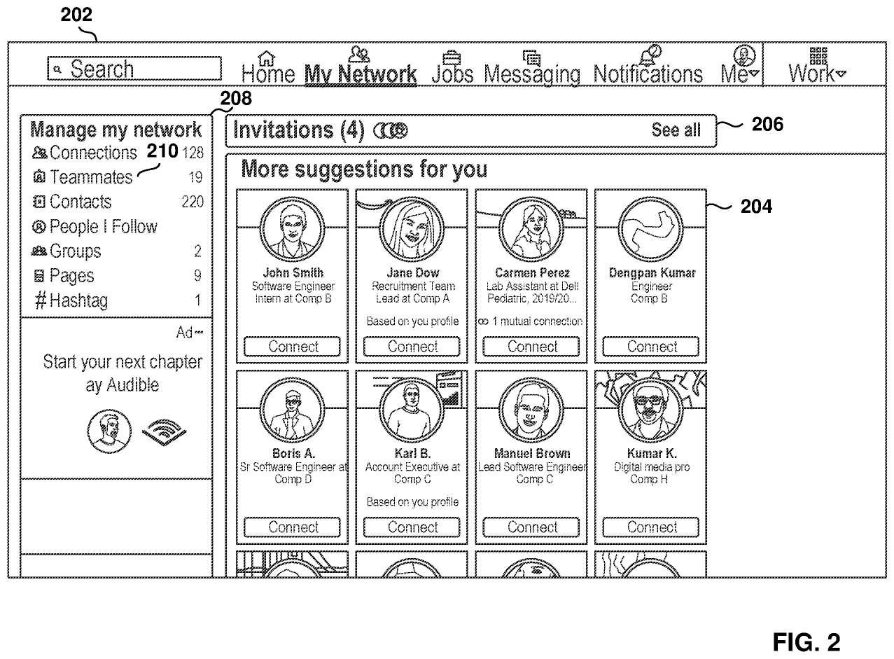

FIG. 2 is a user interface 202 for suggesting teammate connections, according to some example embodiments. The user interface 202 is named “My Network” and provides options 208 for managing the user's connections, including option 210 for managing teammates.

Area 206 is for managing invitations, which includes invitations received pending approval; the invitations may be to add a new connection or add a new teammate. Area 204 provides suggestions for new connections for the user. In some example embodiments, suggestions for adding teammates may also be included (not shown in the example of FIG. 2).

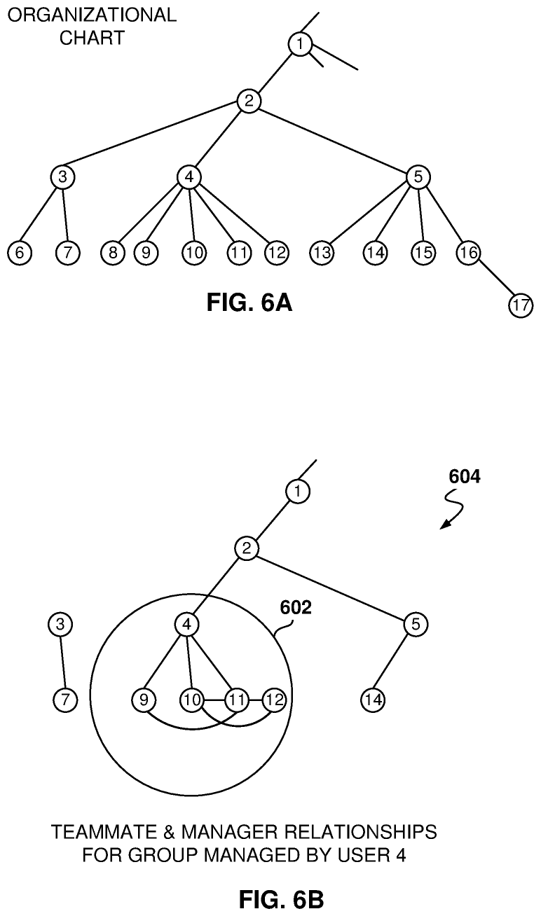

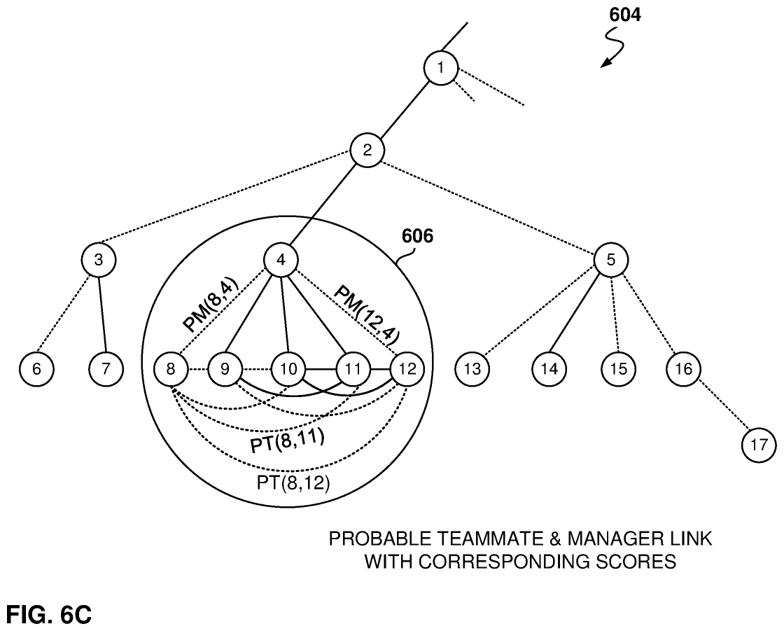

Teammate suggestions may be generated by the social networking service based on information about the user. More details are provided below with reference to FIGS. 6A-6C, 9, and 10 for generating teammate suggestions. To have a confirmed teammate relationship between two users, both users have to approve. Typically, a first user sends an invitation to become a teammate to a second user, and when the second user confirms the teammate relationship, then the teammate relationship is confirmed.

A straightforward method for generating suggestions is to use the known and confirmed teammate connections. For example, if user A is a teammate of user B and user A has user C as a confirmed manager, then user C is a natural suggestion to user B for a manager when user B has not identified a manager yet. Similarly, if user A and user B are established teammates, and user C is a confirmed teammate of user A but not of user B, then suggestions can be generated for users B and C to add each other as a teammate.

In some embodiments, suggestions are provided regarding possible errors in the teammate relationships. If two users have a confirmed peer-teammate relationship, but each user has identified a different manager, then a notification may be sent to one or both users to suggest correcting or validating the manager-teammate relationship.

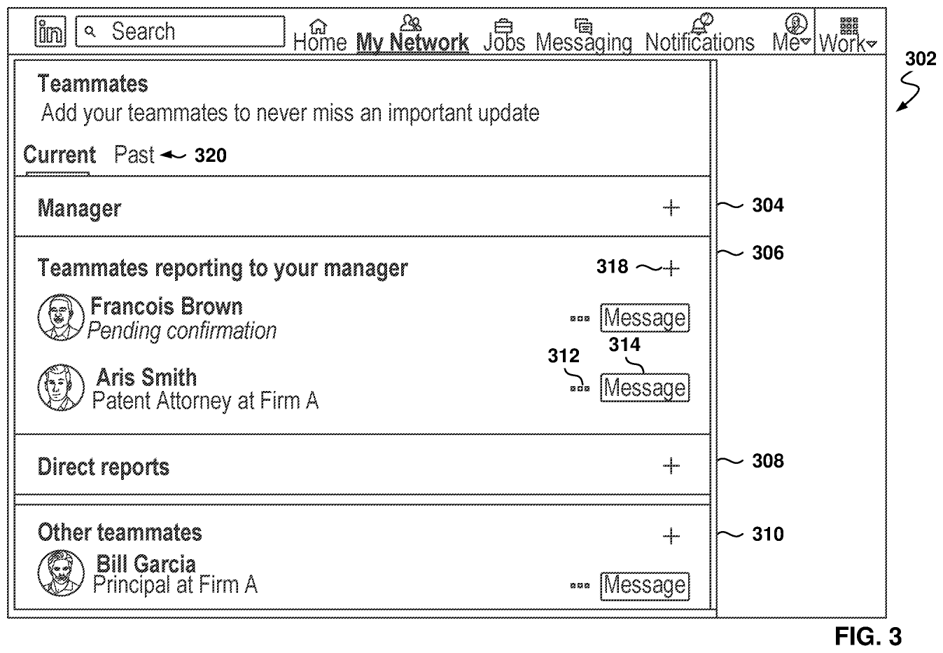

FIG. 3 is a teammate-connections user interface 302 for managing teammate relationships, according to some example embodiments. The teammate-connections user interface 302 provides information about the teammate connections of one user. In the teammate-connections user interface 302, the user can edit, add, and modify the information about the user's teammates.

In some example embodiments, the teammate connections of a user include the manager of the user (e.g., the person to whom the user reports), peers reporting to the same manager, people reporting to the user (e.g., direct reports), and other teammates (e.g., people working closely with the user that are not included in the other types of teammates). In some example embodiments, each user is limited to one manager, but other embodiments contemplate a user having multiple managers. For simplicity of description, the term “teammates” and the equivalent “teammate-connections” in this patent application refer to all categories of teammates, unless otherwise specified, and the peers of the user reporting to the same manager are referred to as “peer teammates” to differentiate from other types of teammates.

The teammate-connections user interface 302 includes options 320 for managing current teammates or past teammates at previous jobs. The example illustrated in FIG. 3 shows the options for the current teammates.

The teammate-connections user interface 302 includes a manager area 304 to present information about the manager, a peer-teammate area 306 to present information about peer teammates, a direct-reports area 308 to present information about direct reports, and other teammates area 310 to present information about other teammates.

Each area presents the corresponding users in that category, although the areas may be empty. An add button 318 is available for the user to add teammates in the different categories. Further, for each teammate, a message-button 314 provides the user the option to send a message to the teammate. Further, a more-options button 312 provides additional options, such as changing a teammate to be a past teammate and removing a teammate.

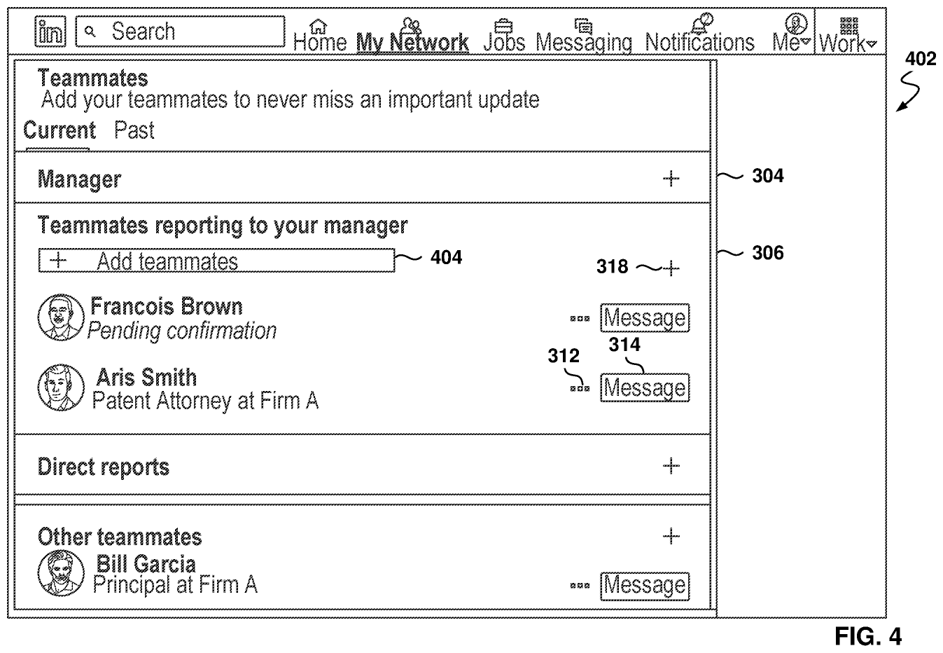

FIG. 4 is a user interface 402 for adding teammate connections, according to some example embodiments. Once the user selects add button 318 to add a new peer teammate, the user interface 402 presents entry field 404 for entering the name of the teammate.

In some example embodiments, as the user types into the entry field 404, searches on the partial typed entry are done among the connections of the user and suggestions are provided so the user does not have to enter the whole name; instead, the user can simply click on one of the suggestions. Once the user clicks on the name, the teammate suggestion is sent to the selected user connection. If the user and the teammate suggestion are not connected in the social networking service, a connection request is also sent to the teammate suggestion. Until the recipient accepts the invitation, this user will be listed as one of the teammates with a status of “pending confirmation.” However, if the recipient is not connected to the user and the recipient has not accepted the connection request yet, then the teammate relationship will have a status of “pending connection.”

There are other possible interfaces for adding teammates. For example, when a user edits the user's profile to enter job information for a new position, the system provides an option to the user to add teammates, similar to the entry field 404. Additionally, if the user changes jobs, the system will provide an option to convert some or all of the present teammates to past teammates when the user enters information for the new position. In some example embodiments, the user interface includes several entry fields, with an entry field for each of the teammate categories: manager, peer, direct report, and other teammates.

Further, if the teammate of a user changes the status of the user to past teammate (e.g., the teammate has changed jobs), then a notification is sent to the user suggesting to move the teammate to past teammates. In some example embodiments, the system automatically changes the status to past teammate without requesting confirmation.

In some example embodiments, the message option 314 includes the ability to send a message (e.g., text, video) or to establish a messaging session with the teammate. Additionally, in some example embodiments, an option is provided for group chats that include all the teammates. That is, a user can send a team-check invitation to some or all of the teammates. For example, the user may send a chat request to all peer teammates, or to peer teammates and the manager, or to all teammates, including manager, peers, direct reports, and other teammates.

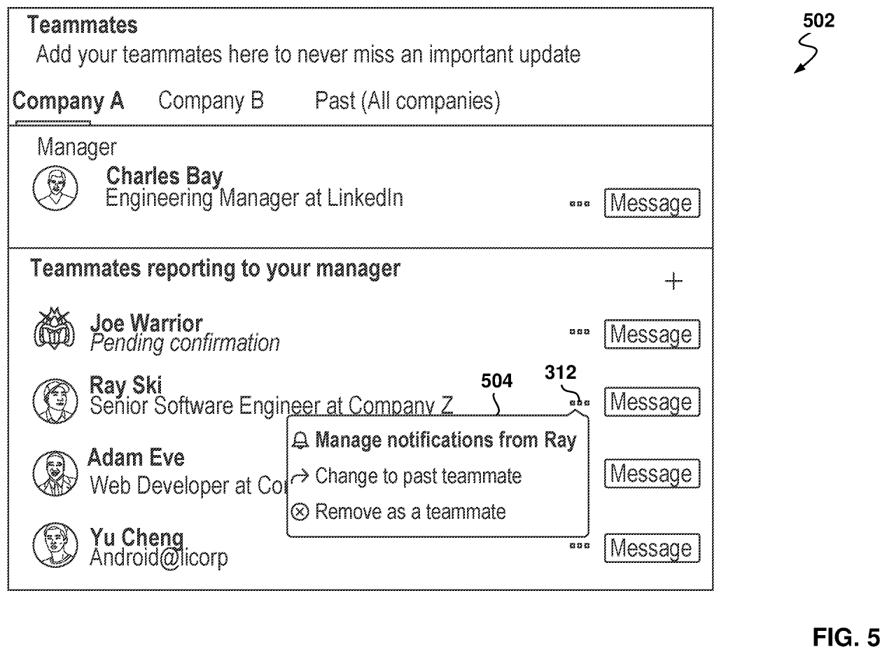

FIG. 5 is a user interface 502 for managing teammate communications, according to some example embodiments. When the user selects the more-options button 312, a window 504 is presented with menu options that include managing notifications from the selected user, changing the selected user to past teammate, and removed the selected user as a teammate.

Typically, users are very interested in notifications from their teammates, so the social networking service prioritizes notifications from teammates. However, some users may not be as interested in notifications from one or more teammates, so the user is given the option to prioritize the notifications from the teammates, e.g., low, medium, or high priority.

When prioritizing the notifications for the user (e.g., notifications from teammates, notifications from other connections, news, invitations to connect, job suggestions), the options configured by the user for teammate notifications are considered to obtain a score for the teammate notification that is ranked with all other notifications. The notifications with the higher scores are then used for presentation to the user.

In some example embodiments, the more-options button 312 is also provided for the group of teammates, so the notifications for all the peer teammates may be configured at the same time without having to configure peer teammates one by one.

In some example embodiments, the teammate notifications may be generated by the teammate (e.g., the teammate posts something on the social networking service) or may be generated by the system based on teammate information (e.g., the birthday of the teammate is coming up).

FIG. 6A is a section of an organizational chart based on teammate connections, according to some example embodiments. The organizational chart by company is a hierarchical structure that contains the social connections. The organizational chart is built based on the manager-teammate, peer-teammate, and direct-report information by placing teammates under one manager at the same level.

Further, the different levels are built by adding manager of manager relationships, until the root of the tree is found, which is likely the Chief Executive Officer (CEO) of the company. The hierarchical organizational chart enables features that are not available in a typical network with unqualified user connections, such as target communications to managers, or to people without direct reports, or to peer teammates of a user, etc.

In some example embodiments, the data structure associated with the organizational chart also includes data about the confirmed peer-teammate relationships. The peer-teammate relationships are not shown in FIG. 6A for simplicity, although they are implicitly present.

The organizational chart of FIG. 6A shows all known, confirmed teammate relationships, but it is likely that some users do not have their teammate relationships confirmed. Therefore, there will be other users not present in this organizational chart. However, the system can infer additional teammate relationships to build a more complete organizational chart for the company, as illustrated in FIG. 6B.

FIG. 6B illustrates the teammate and manager relationships for a group, according to some example embodiments. Organizational chart 604 shows the confirmed teammate relationships. Further, in group 602, which includes user 4 and direct reports, the confirmed peer-teammate relationships are also illustrated.

It can be observed by analyzing group 602 that some relationships are missing. For example, users 9, 10, and 11 have confirmed their manager 4, while user 12 has not. Also, users 9 and 10 have teammates 11 and 12, which means that users 9 and 10 should be also teammates, but their peer-teammate relationship has not been confirmed yet. Further, some teammates may be missing that have not yet established any teammate relationships.

FIG. 6C illustrates the determination of teammate connection scores indicative of a probability of possible teammate connections, according to some example embodiments. The representation of organizational chart 604 has been expanded to include inferred teammate relationships (represented as dotted lines) as well as the confirmed teammate relationships (represented as straight lines).

For example, relationships 8-4 (manager), 8-10 (peer), and 12-4 (manager) have been added as inferred teammate relationships because the social networking service has calculated the probability of these relationships. The probability of a teammate relationship between two users, also referred to herein as teammate score, is the probability that an unconfirmed teammate relationship exists between the two users.

In the example illustrated in FIG. 6C, the probability of a manager relationship is referred to as PM (e.g., between users 8 and 4, PM(8, 4)) and the probability of a peer-teammate relationship is referred to as PT (e.g., between users 8 and 12, PT(8, 12)). In some example embodiments, a teammate relationship is considered to exist between two users when the teammate relationship probability is above a predetermined threshold (e.g., 75%, 80%, 90%, 95%, in a range from 50% to 100%). In the illustrated example, the social networking service has inferred all the non-confirmed teammate relationships within the group 606.

In some example environments, the social networking service provides interfaces for traversing user teammates. For example, a user A may want to see the teammates of a connected user B (not a teammate). User A can click on the profile (or some other user interface) of user B and then an option is provided to see user B's teammates.

Additionally, when viewing teammate information, a user can click in one of the teammates and traverse the organizational chart, such as by clicking on the manager of a given user.

In some example embodiments, a similar organization chart is created for past teammates, where the user can view details of the organizational chart from past companies.

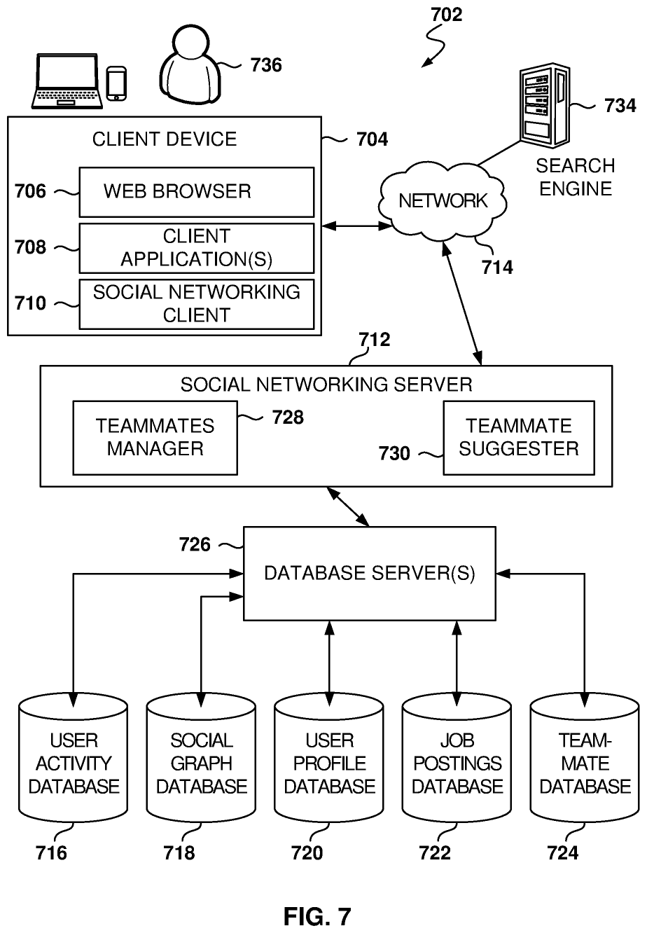

FIG. 7 is a block diagram illustrating a networked system, according to some example embodiments, including a social networking server 712, illustrating an example embodiment of a high-level client-server-based network architecture 702. Embodiments are presented with reference to an online service and, in some example embodiments, the online service is a social networking service.

The social networking server 712 provides server-side functionality via a network 714 (e.g., the Internet or a wide area network (WAN)) to one or more client devices 704. FIG. 7 illustrates, for example, a web browser 706, client application(s) 708, and a social networking client 710 executing on a client device 704. The social networking server 712 is further communicatively coupled with one or more database servers 726 that provide access to one or more databases 716-724.

The social networking server 712 includes, among other modules, a teammates manager 728 and a teammate suggester 730. The teammates manager 728 manages operations regarding the creation, modification, and deletion of teammate relationships, as well as the maintenance of data structures to support teammate functionality. The teammate suggester 730 generates teammate suggestions for users and keeps track of the suggestions presented to each user.

The client device 704 may comprise, but is not limited to, a mobile phone, a desktop computer, a laptop, a portable digital assistant (PDA), a smart phone, a tablet, a netbook, a multi-processor system, a microprocessor-based or programmable consumer electronic system, or any other communication device that a user 736 may utilize to access the social networking server 712. In some embodiments, the client device 704 may comprise a display module (not shown) to display information (e.g., in the form of user interfaces).

In one embodiment, the social networking server 712 is a network-based appliance that responds to initialization requests or search queries from the client device 704. One or more users 736 may be a person, a machine, or other means of interacting with the client device 704. In various embodiments, the user 736 interacts with the network architecture 702 via the client device 704 or another means.

The client device 704 may include one or more applications (also referred to as “apps”) such as, but not limited to, the web browser 706, the social networking client 710, and other client applications 708, such as a messaging application, an electronic mail (email) application, a news application, and the like. In some embodiments, if the social networking client 710 is present in the client device 704, then the social networking client 710 is configured to locally provide the user interface for the application and to communicate with the social networking server 712, on an as-needed basis, for data and/or processing capabilities not locally available (e.g., to access a user profile, to authenticate a user 736, to identify or locate other connected users 736, etc.). Conversely, if the social networking client 710 is not included in the client device 704, the client device 704 may use the web browser 706 to access the social networking server 712.

In addition to the client device 704, the social networking server 712 communicates with the one or more database servers 726 and databases 716-724. In one example embodiment, the social networking server 712 is communicatively coupled to a user activity database 716, a social graph database 718, a user profile database 720, a job postings database 722, and a teammate database 724. The databases 716-724 may be implemented as one or more types of databases including, but not limited to, a hierarchical database, a relational database, an object-oriented database, one or more flat files, or combinations thereof.

The user profile database 720 stores user profile information about users 736 who have registered with the social networking server 712. With regard to the user profile database 720, the user 736 may be an individual person or an organization, such as a company, a corporation, a nonprofit organization, an educational institution, or other such organizations.

In some example embodiments, when a user 736 initially registers to become a user 736 of the social networking service provided by the social networking server 712, the user 736 is prompted to provide some personal information, such as name, age (e.g., birth date), gender, interests, contact information, home town, address, spouse's and/or family users' names, educational background (e.g., schools, majors, matriculation and/or graduation dates, etc.), employment history (e.g., companies worked at, periods of employment for the respective jobs, job title), professional industry (also referred to herein simply as “industry”), skills, professional organizations, and so on. This information is stored, for example, in the user profile database 720. Similarly, when a representative of an organization initially registers the organization with the social networking service provided by the social networking server 712, the representative may be prompted to provide certain information about the organization, such as a company industry.

As users 736 interact with the social networking service provided by the social networking server 712, the social networking server 712 is configured to monitor these interactions. Examples of interactions include, but are not limited to, commenting on posts entered by other users 736, viewing user profiles, editing or viewing a user 736's own profile, sharing content outside of the social networking service (e.g., an article provided by an entity other than the social networking server 712), updating a current status, posting content for other users 736 to view and comment on, posting job suggestions for the users 736, searching job postings, and other such interactions. In one embodiment, records of these interactions are stored in the user activity database 716, which associates interactions made by a user 736 with his or her user profile stored in the user profile database 720.

The job postings database 722 includes job postings offered by companies. Each job posting includes job-related information such as any combination of employer, job title, job description, requirements for the job posting, salary and benefits, geographic location, one or more job skills desired, day the job posting was posted, relocation benefits, and the like.

The teammate database 724 includes information about teammate relationships, including confirmed teammate relationships and inferred teammate relationships. While the database server(s) 726 are illustrated as a single block, one of ordinary skill in the art will recognize that the database server(s) 726 may include one or more such servers. Accordingly, and in one embodiment, the database server(s) 726 implemented by the social networking service are further configured to communicate with the social networking server 712.

The network architecture 702 may also include a search engine 734. Although only one search engine 734 is depicted, the network architecture 702 may include multiple search engines 734. Thus, the social networking server 712 may retrieve search results (and, potentially, other data) from multiple search engines 734. The search engine 734 may be a third-party search engine.

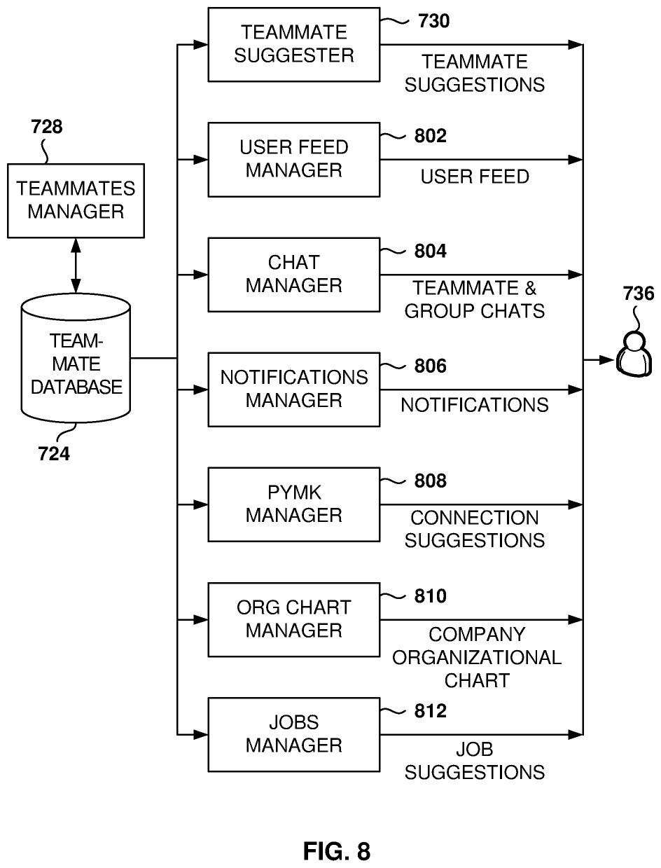

FIG. 8 illustrates the uses of teammate connection information for improving online services, according to some example embodiments. The teammate information is used to improve the social networking services.

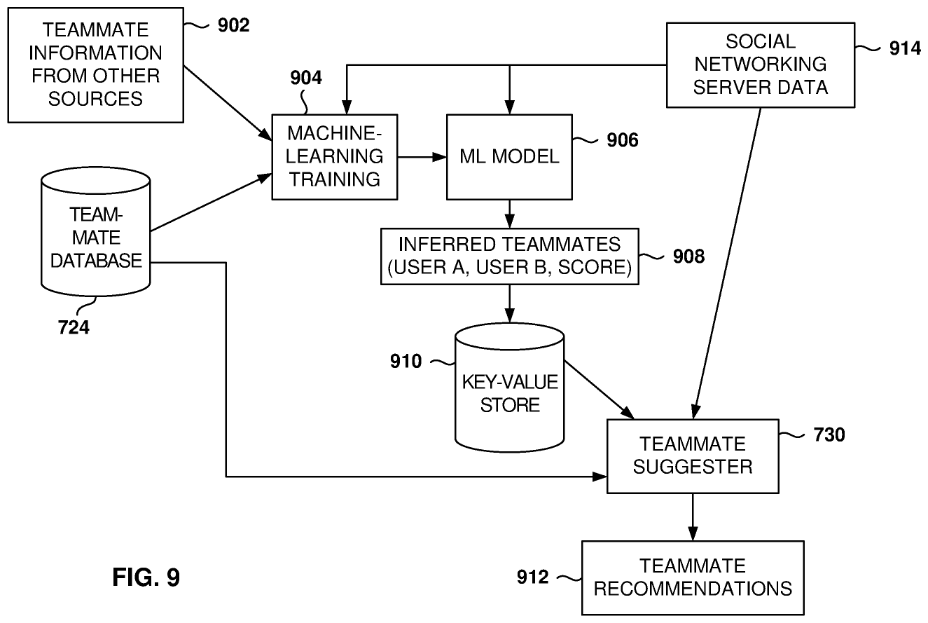

The social networking service uses different methods for calculating information valuable to the user. The social networking service uses several types of information to perform the scoring and ranking to select the information presented to the user or to provide suggestions to the user. These methods may be improved with the use of the teammate information. Many times, the teammate information is combined with other information (e.g., user profile information, user activity information, user connectivity information) to rank items, and then the items at the top of the rank are selected for the user. A detailed example for creating teammate suggestions is provided below with reference to FIG. 9.

The teammate information in teammate database 724 is managed by the teammates manager 728, which calculates the teammate relationships, both confirmed and inferred.

In some example embodiments, the teammate information is used by the teammate suggester 730, user-feed manager 802, chat manager 804, notifications manager 806, PYMK manager 808, organizational-chart manager 810, and jobs manager 812.

The teammates suggester 730 generates teammate suggestions for the user, as described in more detail below with reference to FIG. 9.

The user-feed manager 802 generates the user feed for a given user (e.g., the user feed illustrated in FIG. 1), where the feed may include news, job suggestions, user posts, etc. The teammate information is used to change the priority of teammate-related items (usually to boost the priority, but in some cases the priority may be lowered if the user configures accordingly). For example, the notifications associated with peer teammates and manager teammates are given higher importance than for non-teammate users since most users are very interested in the notifications or communications from teammates.

The chat manager 804 manages communications (e.g., chat sessions, messaging) among teammates. In some example embodiments, the chat manager 804 provides teammate-to-teammate chat as well as group chat for teammates.

The notifications manager 806 manages user's notifications, e.g., new post from a teammate, interesting news, new job suggestions, messages from recruiters, etc. In some example embodiments, the hierarchy of the organizational chart may be used to control communications. For example, the CEO of a company may use a messaging service to send a message to all the teammates under the CEO's command. In other example, a manager may send a notification to the manager's direct reports, the manager's teammates, and direct reports of the manager's teammates. Also, the notifications manager 806 can create teammate-related notifications, such as the birthday of a teammate is coming up or your direct report just had a baby.

The PYMK manager 808 provides suggestions for new connections of the user (different from teammate suggestions). For example, the PYMK manager 808 can use the teammate information to suggest new connections that are direct connections to the user's teammates.

The organizational chart manager 810 creates organizational charts, such as the ones illustrated in FIGS. 6A-6C.

The jobs manager 812 provides the job recommendations for the user. The jobs manager 812 uses the teammate information to refine the quality of the job suggestions. For example, if a present teammate or a past teammate gets a job at a new company, the jobs manager 812 may give higher priority to jobs at the new company since teammates tend to have similar career interests. Also, having a teammate in the new company may open doors for the user.

FIG. 9 illustrates the use of social networking service data to generate teammate recommendations, according to some example embodiments. Teammate information from other sources 902 is used for the machine-learning training 904. The teammate information from other sources 902 includes additional data that provides teammate information, such as organizational data configured by an organization in an email application (e.g., Microsoft Outlook). This organizational data includes information about managers and direct reports.

Another source of teammate information comes from binding multiple identities to the same user (e.g., different emails). For example, a user may configure an email client to receive email from multiple accounts, or a user may enter this information in the profile section of the online service.

It is noted that the social networking service protects the privacy of the users and provides users options for controlling the use of their data. Additionally, consent from companies is required if needed to protect user confidentiality and privacy.

The information from the teammate database 724 (e.g., confirmed and inferred teammate relationships for current and past teammates), the teammate information from other sources 902, and the social networking server data (e.g., user profiles, user connections) are used by the machine-learning training 904 to generate a ML model 906 that provides inferred teammates 908, which are estimates on possible teammates.

In some example embodiments, the inferred teammates 908 includes a score for a pair of users, represented as (ID of user 1, ID of user 2, score). The score indicates the probability that the users are teammates.

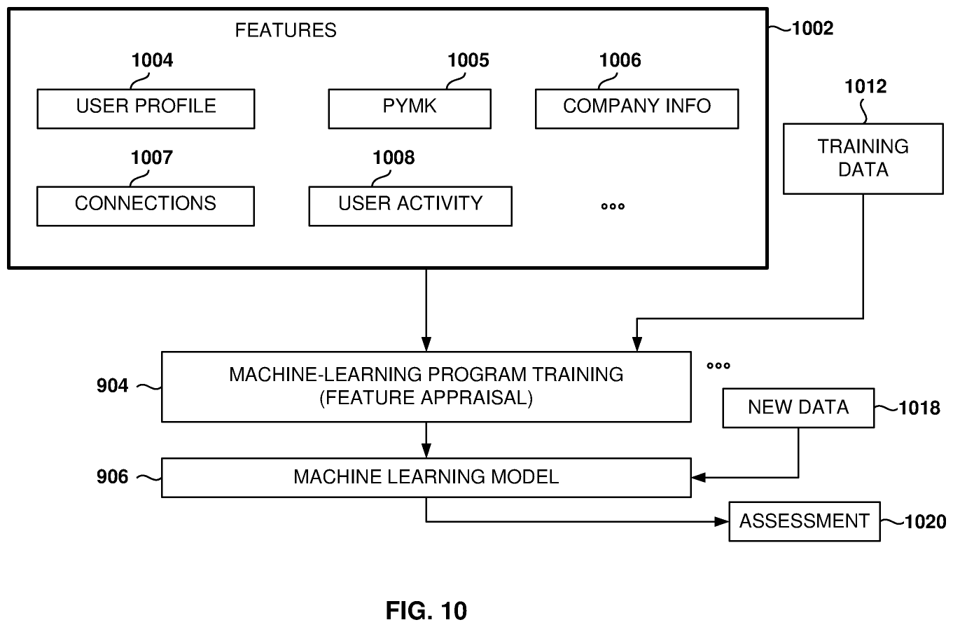

The social networking server data 914 includes information about users' current jobs, which includes the company. Therefore, the social networking server data 914 has information about users within a company to limit teammate searches to that company. More details about the ML training 904 are provided below with reference to FIG. 10.

In some example embodiments, the search for possible teammates of a user is bounded by the company of the user; that is, the possible teammates work at the same company. In some example embodiments, the company scope for the search also includes subsidiaries of one company.

For example, if the company has 100,000 employees, the social networking service calculates probabilities that each pair of employees are teammates. In some example embodiments, the calculations are performed by a groups of people in the same area (e.g., functional area such as engineering or marketing) to reduce the number of pairs for calculating the score.

The inferred teammates 908 is stored in a key-value store, which is a database containing processed data. In some example embodiments, the key-value store is used instead of the teammate database 724 by the different services, as illustrated in FIG. 8. It is noted that the inferred teammates 908 may be calculated for current teammates and past teammates.

In the example of FIG. 9, the teammate suggester 730 utilizes the data from one or more of the key-value store 910 and the teammate database 724, on the social networking server data 914, to generate teammate recommendations 912. In one embodiment, the teammate suggester 730 selects pairs of users with inferred teammates 908 scores above a predetermined threshold to generate the teammate recommendations.

It is noted that, in other example embodiments, inferred teammates 908 may also be calculated using heuristic methods, or with a combination of heuristic methods and machine-learning models. The heuristic methods use the organizational chart to identify possible teammates. For example, the confirmed peer teammate of a confirmed peer teammate should also be a peer teammate. Also, if a user has a confirmed manager, the peer teammates of the user will probably have the same manager.

When combining the ML model 906 with heuristic methods, the initial score provided by the ML model 906 can be boosted or decreased based on heuristics. For example, if a high score for peer teammate is calculated by the ML model for two users, the score can be lowered if the two users have different confirmed managers.

FIG. 10 illustrates the training and use of a machine-learning program, according to some example embodiments. In some example embodiments, machine-learning programs (MLPs), also referred to as machine-learning algorithms or tools, are utilized to perform operations associated with searches, such as video matching.

Machine Learning is an application that provides computer systems the ability to perform tasks, without explicitly being programmed, by making inferences based on patterns found in the analysis of data. Machine learning explores the study and construction of algorithms, also referred to herein as tools, that may learn from existing data and make predictions about new data. Such machine-learning algorithms operate by building an ML model 906 from example training data 1012 in order to make data-driven predictions or decisions expressed as outputs or assessments 1020. Although example embodiments are presented with respect to a few machine-learning tools, the principles presented herein may be applied to other machine-learning tools.

Data representation refers to the method of organizing the data for storage on a computer system, including the structure for the identified features and their values. In ML, it is typical to represent the data in vectors or matrices of two or more dimensions. When dealing with large amounts of data and many features, data representation is important so that the training is able to identify the correlations within the data.

There are two common modes for ML: supervised ML and unsupervised ML. Supervised ML uses prior knowledge (e.g., examples that correlate inputs to outputs or outcomes) to learn the relationships between the inputs and the outputs. The goal of supervised ML is to learn a function that, given some training data, best approximates the relationship between the training inputs and outputs so that the ML model can implement the same relationships when given inputs to generate the corresponding outputs. Unsupervised ML is the training of an ML algorithm using information that is neither classified nor labeled, and allowing the algorithm to act on that information without guidance. Unsupervised ML is useful in exploratory analysis because it can automatically identify structure in data.

Common tasks for supervised ML are classification problems and regression problems. Classification problems, also referred to as categorization problems, aim at classifying items into one of several category values (for example, is this object an apple or an orange?). Regression algorithms aim at quantifying some items (for example, by providing a score to the value of some input). Some examples of commonly used supervised-ML algorithms are Logistic Regression (LR), Naive-Bayes, Random Forest (RF), neural networks (NN), deep neural networks (DNN), matrix factorization, and Support Vector Machines (SVM).

Some common tasks for unsupervised ML include clustering, representation learning, and density estimation. Some examples of commonly used unsupervised-ML algorithms are K-means clustering, principal component analysis, and autoencoders.

In some embodiments, example ML models 906 provide a teammate score indicating the probability that two users are teammates and a teammate type indicating whether the teammate relationship is manager teammate, peer teammate, direct-report teammate, or other type of teammate.

The training data 1012 comprises examples of values for the features 1002. In some example embodiments, the training data 1012 comprises labeled data with examples of values for the features 1002 and labels indicating the outcome, such as confirmed-teammate relationships. The machine-learning algorithms utilize the training data 1012 to find correlations among identified features 1002 that affect the outcome. A feature 1002 is an individual measurable property of a phenomenon being observed. The concept of a feature is related to that of an explanatory variable used in statistical techniques such as linear regression. Choosing informative, discriminating, and independent features is important for effective operation of ML in pattern recognition, classification, and regression. Features may be of different types, such as numeric features, strings, and graphs.

In one example embodiment, the features 1002 may be of different types and may include one or more of user profile 1004, PYMK 1005 (e.g., suggestions generated by the social networking service for possible connections), company information 1006 (in some cases, the company information is part of the user profile 1004, but other company information may be available from other sources (e.g., as organizational data provided by an email service)), connections information 1007 (e.g., establish connections within the social networking service, confirm teammate relationships within the social networking service), and user activity 1008 (e.g., user posts, clicks on the user feed, messaging data), etc.

During training 904, the ML algorithm analyzes the training data 1012 based on identified features 1002 and configuration parameters defined for the training 904. The result of the training 904 is an ML model 906 that is capable of taking inputs to produce assessments.

When the ML model 906 is used to perform an assessment (e.g., teammate suggestions, PYMK suggestions, selection of items for the user feed), new data 1018 is provided as an input to the ML model 906, and the ML model 906 generates the assessment 1020 as output.

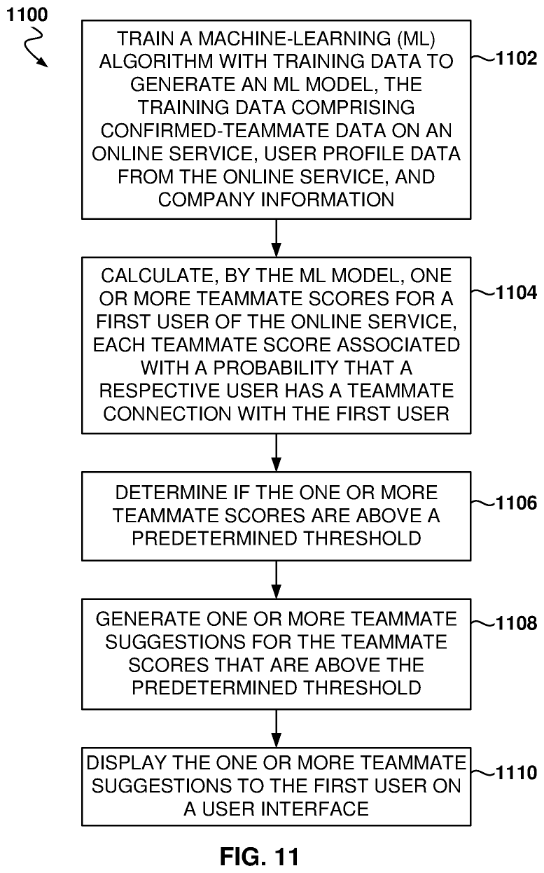

FIG. 11 is a flowchart of a method 1100 for determining teammate connections, according to some example embodiments. While the various operations in this flowchart are presented and described sequentially, one of ordinary skill will appreciate that some or all of the operations may be executed in a different order, be combined or omitted, or be executed in parallel.

Operation 1102 is for training, by one or more processors, a machine-learning (ML) algorithm with training data to generate an ML model. The training data includes confirmed-teammate data on an online service, user profile data from the online service, and company information.

From operation 1102, the method 1100 flows to operation 1104 where the one or more processors calculate, using the ML model, one or more teammate scores for a first user of the online service. Each teammate score is associated with a probability that a respective user has a teammate connection with the first user.

From operation 1104, the method 1100 flows to operation 1106 for determining, by the one or more processors, if the one or more teammate scores are above a predetermined threshold.

From operation 1106, the method 1100 flows to operation 1108 where the one or more processors generate one or more teammate suggestions for the teammate scores that are above the predetermined threshold.

From operation 1108, the method 1100 flows to operation 1110 for displaying, by the one or more processors, the one or more teammate suggestions to the first user on a user interface.

In one example, the method 1100 further comprises receiving confirmation from the first user that the first user has the teammate connection with a second user, receiving confirmation from the second user that the first user has the teammate connection with the second user, and establishing a confirmed teammate relationship between the first user and the second user.

In one example, a category of the teammate connection is selected from a group consisting of manager, peer, direct report, and other.

In one example, the method 1100 further comprises, for a teammate suggestion between the first user and a second user, utilizing a heuristic model to generate a heuristic score; and changing the teammate score for the first user and the second user based on the heuristic scores.

In one example, the confirmed-teammate data comprises teammate connections confirmed by the users associated with each teammate connection.

In one example, the user profile data includes, for the first user, one or more of job experience information, company information, education information, and activity information of the first user.

In one example, the method 1100 further comprises accessing, by a user feed manager, teammate connection information for the first user; and prioritizing, by the user feed manager, items presented on a user feed of the first user based on the teammate connection information for the first user.

In one example, the method 1100 further comprises accessing, by a notifications manager, teammate connection information for the first user; and prioritizing, by the notifications manager, notifications sent to the first user based on the teammate connection information for the first user.

In one example, the method 1100 further comprises accessing, by a people-you-may-know (PYMK) manager, teammate connection information for the first user; and prioritizing, by the PYMK manager, possible connections on the online service presented to the first user based on the teammate connection information for the first user.

In one example, the method 1100 further comprises accessing, by an organizational-chart manager, teammate connection information for users in a first company; and calculating, by the organizational-chart manager, an organizational chart for the first company based on the teammate connection information for the users in the first company.

Another general aspect is for a system that includes a memory comprising instructions and one or more computer processors. The instructions, when executed by the one or more computer processors, cause the one or more computer processors to perform operations comprising: training a machine-learning (ML) algorithm with training data to generate an ML model, the training data comprising confirmed-teammate data on an online service, user profile data from the online service, and company information; calculating, by the ML model, one or more teammate scores for a first user of the online service, each teammate score associated with a probability that a respective user has a teammate connection with the first user; determining if the one or more teammate scores are above a predetermined threshold; generating one or more teammate suggestions for the teammate scores that are above the predetermined threshold; and displaying the one or more teammate suggestions to the first user on a user interface.

In yet another general aspect, a machine-readable storage medium (e.g., a non-transitory storage medium) includes instructions that, when executed by a machine, cause the machine to perform operations comprising: training a machine-learning (ML) algorithm with training data to generate an ML model, the training data comprising confirmed-teammate data on an online service, user profile data from the online service, and company information; calculating, by the ML model, one or more teammate scores for a first user of the online service, each teammate score associated with a probability that a respective user has a teammate connection with the first user; determining if the one or more teammate scores are above a predetermined threshold; generating one or more teammate suggestions for the teammate scores that are above the predetermined threshold; and displaying the one or more teammate suggestions to the first user on a user interface.

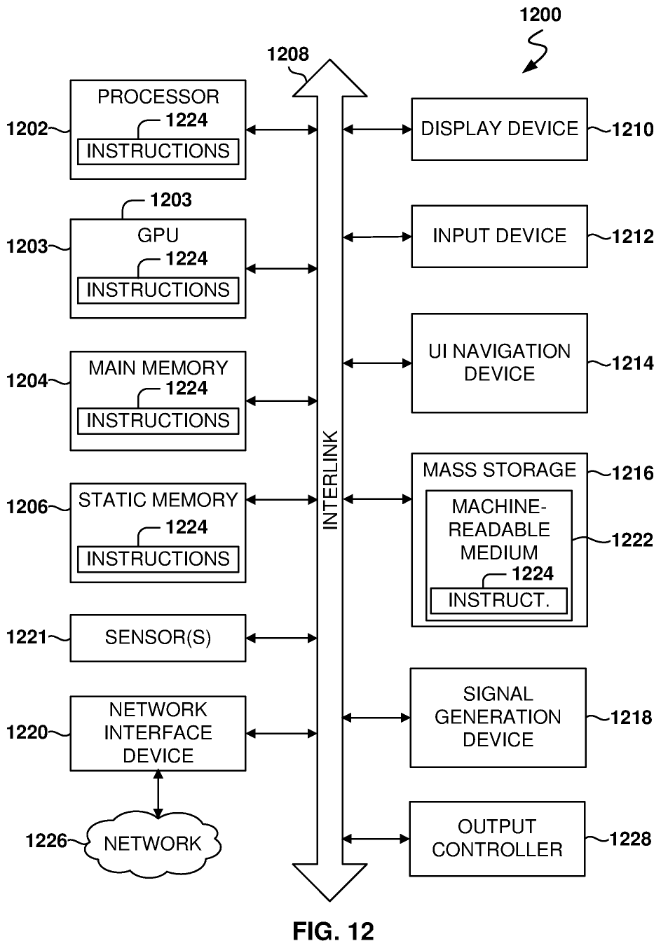

FIG. 12 is a block diagram illustrating an example of a machine 1200 upon or by which one or more example process embodiments described herein may be implemented or controlled. In alternative embodiments, the machine 1200 may operate as a standalone device or may be connected (e.g., networked) to other machines. In a networked deployment, the machine 1200 may operate in the capacity of a server machine, a client machine, or both in server-client network environments. In an example, the machine 1200 may act as a peer machine in a peer-to-peer (P2P) (or other distributed) network environment. Further, while only a single machine 1200 is illustrated, the term “machine” shall also be taken to include any collection of machines that individually or jointly execute a set (or multiple sets) of instructions to perform any one or more of the methodologies discussed herein, such as via cloud computing, software as a service (SaaS), or other computer cluster configurations.

Examples, as described herein, may include, or may operate by, logic, a number of components, or mechanisms. Circuitry is a collection of circuits implemented in tangible entities that include hardware (e.g., simple circuits, gates, logic). Circuitry membership may be flexible over time and underlying hardware variability. Circuitries include members that may, alone or in combination, perform specified operations when operating. In an example, hardware of the circuitry may be immutably designed to carry out a specific operation (e.g., hardwired). In an example, the hardware of the circuitry may include variably connected physical components (e.g., execution units, transistors, simple circuits) including a computer-readable medium physically modified (e.g., magnetically, electrically, by moveable placement of invariant massed particles) to encode instructions of the specific operation. In connecting the physical components, the underlying electrical properties of a hardware constituent are changed (for example, from an insulator to a conductor or vice versa). The instructions enable embedded hardware (e.g., the execution units or a loading mechanism) to create members of the circuitry in hardware via the variable connections to carry out portions of the specific operation when in operation. Accordingly, the computer-readable medium is communicatively coupled to the other components of the circuitry when the device is operating. In an example, any of the physical components may be used in more than one member of more than one circuitry. For example, under operation, execution units may be used in a first circuit of a first circuitry at one point in time and reused by a second circuit in the first circuitry, or by a third circuit in a second circuitry, at a different time.

The machine (e.g., computer system) 1200 may include a hardware processor 1202 (e.g., a central processing unit (CPU), a hardware processor core, or any combination thereof), a graphics processing unit (GPU) 1203, a main memory 1204, and a static memory 1206, some or all of which may communicate with each other via an interlink (e.g., bus) 1208. The machine 1200 may further include a display device 1210, an alphanumeric input device 1212 (e.g., a keyboard), and a user interface (UI) navigation device 1214 (e.g., a mouse). In an example, the display device 1210, alphanumeric input device 1212, and UI navigation device 1214 may be a touch screen display. The machine 1200 may additionally include a mass storage device (e.g., drive unit) 1216, a signal generation device 1218 (e.g., a speaker), a network interface device 1220, and one or more sensors 1221, such as a Global Positioning System (GPS) sensor, compass, accelerometer, or another sensor. The machine 1200 may include an output controller 1228, such as a serial (e.g., universal serial bus (USB)), parallel, or other wired or wireless (e.g., infrared (IR), near field communication (NFC)) connection to communicate with or control one or more peripheral devices (e.g., a printer, card reader).

The mass storage device 1216 may include a machine-readable medium 1222 on which is stored one or more sets of data structures or instructions 1224 (e.g., software) embodying or utilized by any one or more of the techniques or functions described herein. The instructions 1224 may also reside, completely or at least partially, within the main memory 1204, within the static memory 1206, within the hardware processor 1202, or within the GPU 1203 during execution thereof by the machine 1200. In an example, one or any combination of the hardware processor 1202, the GPU 1203, the main memory 1204, the static memory 1206, or the mass storage device 1216 may constitute machine-readable media.

While the machine-readable medium 1222 is illustrated as a single medium, the term “machine-readable medium” may include a single medium, or multiple media, (e.g., a centralized or distributed database, and/or associated caches and servers) configured to store the one or more instructions 1224.

The term “machine-readable medium” may include any medium that is capable of storing, encoding, or carrying instructions 1224 for execution by the machine 1200 and that cause the machine 1200 to perform any one or more of the techniques of the present disclosure, or that is capable of storing, encoding, or carrying data structures used by or associated with such instructions 1224. Non-limiting machine-readable medium examples may include solid-state memories, and optical and magnetic media. In an example, a massed machine-readable medium comprises a machine-readable medium 1222 with a plurality of particles having invariant (e.g., rest) mass. Accordingly, massed machine-readable media are not transitory propagating signals. Specific examples of massed machine-readable media may include non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; and CD-ROM and DVD-ROM disks.

The instructions 1224 may further be transmitted or received over a communications network 1226 using a transmission medium via the network interface device 1220.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

As used herein, the term “or” may be construed in either an inclusive or exclusive sense. Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

What is claimed is:

1. A method comprising:
training, by one or more processors, a machine-learning (ML) algorithm with training data to generate an ML model, the training data comprising confirmed-teammate data on an online service, user profile data from the online service, and company information;
calculating, by the one or more processors using the ML model, one or more teammate scores for a first user of the online service, each teammate score associated with a probability that a respective user has a teammate connection with the first user;
determining, by the one or more processors, if the one or more teammate scores are above a predetermined threshold;
generating, by the one or more processors, one or more teammate suggestions for the teammate scores that are above the predetermined threshold; and
displaying, by the one or more processors, the one or more teammate suggestions to the first user on a user interface.

2. The method as recited in claim 1, further comprising:
receiving confirmation from the first user that the first user has the teammate connection with a second user;
receiving confirmation from the second user that the first user has the teammate connection with the second user; and
establishing a confirmed teammate relationship between the first user and the second user.

3. The method as recited in claim 1, wherein a category of the teammate connection is selected from a group consisting of manager, peer, direct report, and other.

4. The method as recited in claim 1, further comprising:
for a teammate suggestion between the first user and a second user, utilizing a heuristic model to generate a heuristic score; and
changing the teammate score for the first user and the second user based on the heuristic score.

5. The method as recited in claim 1, wherein the confirmed-teammate data comprises teammate connections confirmed by the users associated with each teammate connection.

6. The method as recited in claim 1, wherein the user profile data includes, for the first user, one or more of job experience information, company information, education information, and activity information of the first user.

7. The method as recited in claim 1, further comprising:
accessing, by a user feed manager, teammate connection information for the first user; and
prioritizing, by the user feed manager, items presented on a user feed of the first user based on the teammate connection information for the first user.

8. The method as recited in claim 1, further comprising:
accessing, by a notifications manager, teammate connection information for the first user; and
prioritizing, by the notifications manager, notifications sent to the first user based on the teammate connection information for the first user.

9. The method as recited in claim 1, further comprising:
accessing, by a people-you-may-know (PYMK) manager, teammate connection information for the first user; and
prioritizing, by the PYMK manager, possible connections on the online service presented to the first user based on the teammate connection information for the first user.

10. The method as recited in claim 1, further comprising:
accessing, by an organizational-chart manager, teammate connection information for users in a first company; and
calculating, by the organizational-chart manager, an organizational chart for the first company based on the teammate connection information for the users in the first company.

11. A system comprising:
a memory comprising instructions; and
one or more computer processors, wherein the instructions, when executed by the one or more computer processors, cause the system to perform operations comprising:
training a machine-learning (ML) algorithm with training data to generate an ML model, the training data comprising confirmed-teammate data on an online service, user profile data from the online service, and company information;
calculating, by the ML model, one or more teammate scores for a first user of the online service, each teammate score associated with a probability that a respective user has a teammate connection with the first user;
determining if the one or more teammate scores are above a predetermined threshold;
generating one or more teammate suggestions for the teammate scores that are above the predetermined threshold; and
displaying the one or more teammate suggestions to the first user on a user interface.

12. The system as recited in claim 11, wherein the instructions further cause the one or more computer processors to perform operations comprising:
receiving confirmation from the first user that the first user has the teammate connection with a second user;
receiving confirmation from the second user that the first user has the teammate connection with the second user; and
establishing a confirmed teammate relationship between the first user and the second user.

13. The system as recited in claim 11, wherein a category of the teammate connection is selected from a group consisting of manager, peer, direct report, and other.

14. The system as recited in claim 11, wherein the instructions further cause the one or more computer processors to perform operations comprising:
for a teammate suggestion between the first user and a second user, utilizing a heuristic model to generate a heuristic score; and
changing the teammate score for the first user and the second user based on the heuristic score.

15. The system as recited in claim 11, wherein the confirmed-teammate data comprises teammate connections confirmed by the users associated with each teammate connection.

16. A non-transitory machine-readable storage medium including instructions that, when executed by a machine, cause the machine to perform operations comprising:
training a machine-learning (ML) algorithm with training data to generate an ML model, the training data comprising confirmed-teammate data on an online service, user profile data from the online service, and company information;
calculating, by the ML model, one or more teammate scores for a first user of the online service, each teammate score associated with a probability that a respective user has a teammate connection with the first user;
determining if the one or more teammate scores are above a predetermined threshold;
generating one or more teammate suggestions for the teammate scores that are above the predetermined threshold; and
displaying the one or more teammate suggestions to the first user on a user interface.

17. The non-transitory machine-readable storage medium as recited in claim 16, wherein the machine further performs operations comprising:
receiving confirmation from the first user that the first user has the teammate connection with a second user;
receiving confirmation from the second user that the first user has the teammate connection with the second user; and
establishing a confirmed teammate relationship between the first user and the second user.

18. The non-transitory machine-readable storage medium as recited in claim 16, wherein a category of the teammate connection is selected from a group consisting of manager, peer, direct report, and other.

19. The non-transitory machine-readable storage medium as recited in claim 16, wherein the machine further performs operations comprising:
for a teammate suggestion between the first user and a second user, utilizing a heuristic model to generate a heuristic score; and
changing the teammate score for the first user and the second user based on the heuristic score.

20. The non-transitory machine-readable storage medium as recited in claim 16, wherein the confirmed-teammate data comprises teammate connections confirmed by the users associated with each teammate connection.
